(19) United States
(12) Patent Application Publication
(10) Pub. No.: US 2020/0340816 A1
(43) Pub. Date: Oct. 29, 2020

(54) HYBRID POSITIONING SYSTEM WITH SCENE DETECTION

(71) Applicant: MEDIATEK INC., Hsin-Chu (TW)

(72) Inventors: Ting-En Tseng, Hsin-Chu (TW); Tsung-Yu Chiou, Hsin-Chu (TW)

(21) Appl. No.: 16/395,250

(22) Filed: Apr. 26, 2019

(51) Int. Cl. G01C 21/32; G01C 21/16; G01S 19/49; G01C 21/14; G01C 22/00; G01C 17/28

(52) U.S. Cl. CPC G01C 21/32; G01C 21/165; G01C 17/28; G01C 21/14; G01C 22/00; G01S 19/49

(57) ABSTRACT

The present invention provides a method for performing positioning operations, wherein the method includes the steps of: receiving first positioning information from a first source; receiving second positioning information from a second source; obtaining surrounding environment information of a vehicle from a sensor; and referring to the surrounding environment information to determine a positioning strategy to use at least one of the first positioning information and the second positioning information to obtain a location of the vehicle.

### BACKGROUND

In a vehicle navigation system including Global Navigation Satellite System (GNSS) and inertial sensors, the location of the vehicle may have an error and/or the navigation may be misled when the GNSS signals are poor and unreliable. The quality of the GNSS signals will be affected by the surrounding environment, for example, the commercial GNSS chipsets perform well in open sky scenario, but the accuracy may be seriously degraded when the vehicle is in urban canyon or tunnel. In the conventional art, the inertial sensors can also be used to estimate the location of the vehicle, however, how to determine the trust levels of the GNSS and the inertial sensors, and how to determine the switch time between the GNSS and the inertial sensors are important topics.

### SUMMARY

It is therefore an objective of the present invention to provide a hybrid positioning system, which uses surrounding environment information captured by a sensor to determine a positioning strategy to calculate a location of the vehicle accurately, to solve the above-mentioned problems.

According to one embodiment of the present invention, a method for performing positioning operations is disclosed, wherein the method includes the steps of: receiving first positioning information from a first source; receiving second positioning information from a second source; obtaining surrounding environment information of a vehicle from a sensor; and referring to the surrounding environment information to determine a positioning strategy to use at least one of the first positioning information and the second positioning information to obtain a location of the vehicle.

According to another embodiment of the present invention, a processing circuit applied to a vehicle navigation system is disclosed, wherein the processing circuit is configured to receive first positioning information from a first source, receive second positioning information from a second source, obtain surrounding environment information of a vehicle from a sensor, and refer to the surrounding environment information to determine a positioning strategy to use at least one of the first positioning information and the second positioning information to obtain a location of the vehicle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a hybrid positioning system 100 according to one embodiment of the present invention.

FIG. 2 shows that the hybrid positioning system determines that the vehicle is at open sky.

FIG. 3 shows that the hybrid positioning system determines that the vehicle is in the urban canyon.

FIG. 4 shows the top-view visual sensor within the hybrid positioning system according to one embodiment of the present invention.

FIG. 5 is a flowchart of a method for performing positioning operations according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

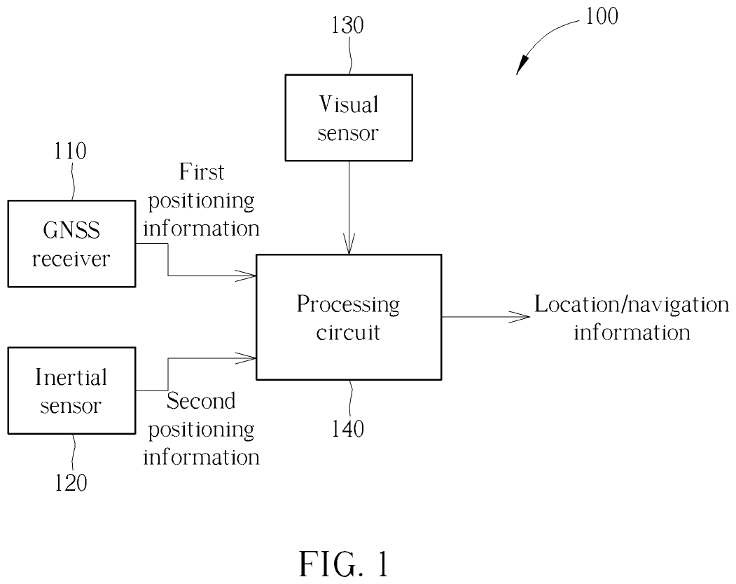

FIG. 1 is a diagram illustrating a hybrid positioning system 100 according to one embodiment of the present invention. As shown in FIG. 1, the hybrid positioning system 100 comprises a GNSS receiver 110, an inertial sensor 120, a visual sensor 130 and a processing circuit 140. In this embodiment, the hybrid positioning system 100 is used in a vehicle, and the visual sensor 130 is mounted on the vehicle. In this embodiment, the visual sensor 130 may be a camera, a LiDar, a millimeter wave radar, an ultrasonic radar or an infrared radar.

In the operations of the hybrid positioning system 100, the GNSS receiver 110 is arranged to receive satellite signals of a plurality of satellites to generate first positioning information to the processing circuit 140. The inertial sensor 120 may comprise an accelerometer, a gyroscope, a magnetometer, or odometer, and provide second positioning information to the processor circuit 140. The visual sensor 130 is arranged to capture the sensing data of the surrounding environment to generate surrounding environment information to the processor circuit 140. Then, the processing circuit 140 refers to the surrounding environment information to determine a positioning strategy or a dead reckoning strategy to use at least one of the first positioning information and the second positioning information to estimate location or navigation information of the vehicle. In the following descriptions, because the present invention focuses on using the surrounding environment information to determine the positioning strategy, and the operations of the GNSS receiver 110 and the inertial sensor 120 are known by a person skilled in the art, the details descriptions of the GNSS receiver 110 and the inertial sensor 120 are omitted here.

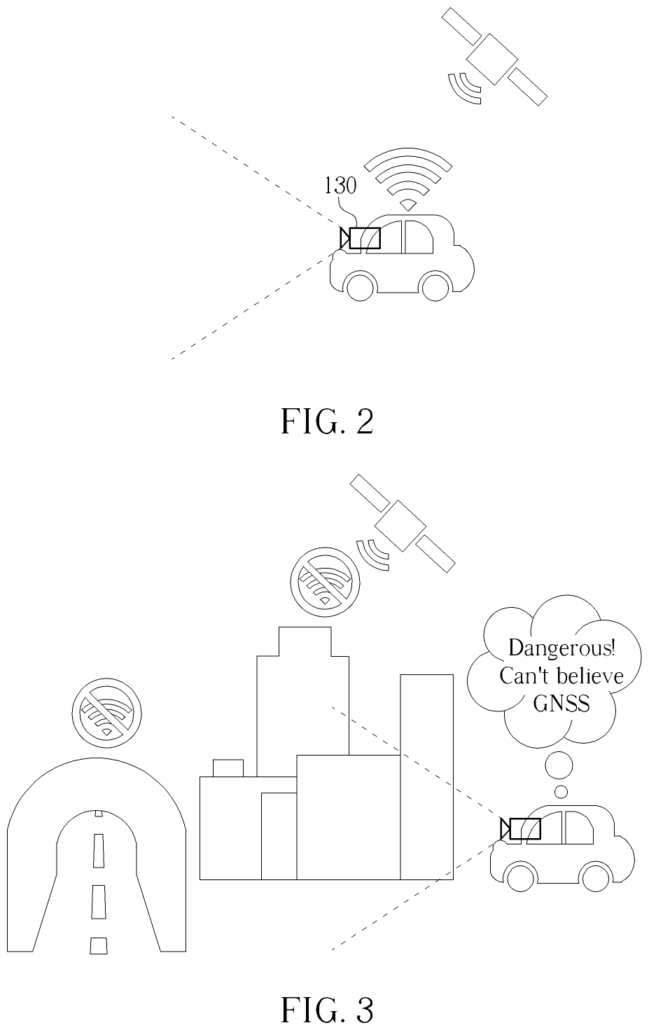

In this embodiment, because the quality of the satellite signals may become worse when there is a barrier covered between the satellite(s) and the vehicle (e.g. the vehicle is in the urban canyon or the tunnel), the processing circuit 140 can refer to the surrounding environment information to determine if the satellite signals becomes bad or will be become worse, to determine a suitable positioning strategy to accurately determine the location or navigation information of the vehicle. Specifically, if the surrounding environment information provided by the visual sensor 130 indicates that the vehicle is at open sky as shown in FIG. 2, it means that the vehicle can receive the satellite signals with high quality and the first positioning information provided by the GNSS receiver 110 is reliable, so the processing circuit 140 can only use the first positioning information, without using the second positioning information provided by the inertial sensor 120, to determine the location and navigation information of the vehicle; or the processing circuit 140 increases the confidence of the first positioning information and lowers the confidence of the second positioning information, and uses the first positioning information and the second positioning information and the corresponding confidences to determine the location and navigation information of the vehicle. On the other hand, if the surrounding environment information provided by the visual sensor 130 indicates that the vehicle is in the urban canyon or the tunnel as shown in FIG. 3, it means that the vehicle cannot receive trustworthy satellite signals or the received satellite signals have had good quality, and the first positioning information provided by the GNSS receiver 110 is not reliable (now or in the future), so the processing circuit 140 can only use the second positioning information, without using the first positioning information provided by the GNSS receiver 110, to determine the location and navigation information of the vehicle; or the processing circuit 140 increases the confidence of the second positioning information and lowers the confidence of the first positioning information, and uses the first positioning information and the second positioning information and the corresponding confidence to determine the location and navigation information of the vehicle.

In one embodiment, the processing circuit 140 has many scene categories and their corresponding confidences of the first positioning information and second positioning information, and the processing circuit 140 can refer to the surrounding environment information to determine one of the scene categories that best matches the environmental data captured by the visual sensor 130, to obtain the appropriate individual confidence of the first positioning information and second positioning information.

In one embodiment, the visual sensor 130 is used to capture the data in front of the vehicle as shown in FIG. 2 and FIG. 3, so the surrounding environment information can indicate the environment that the vehicle will be arrive, and the processing circuit 140 may pre-switch the positioning strategy. In detail, if the data captured by the visual sensor 130 shows many tall buildings, the processing circuit 140 may refer to the surrounding environment information to only use the second positioning information to determine the location and navigation information of the vehicle, or the processing circuit 140 increases the confidence of the second positioning information and lowers the confidence of the first positioning information, even if the current satellite signals are good enough to obtain the accurate location and navigation information of the vehicle.

In this embodiment, the surrounding environment information provided by the visual sensor 130 comprise the captured data (e.g. image data), and the processing circuit 140 can use some image recognition method, such as a semantic segmentation method or a deep learning based scene classification, to determine the scene category of the vehicle, to determine the appropriate positioning strategy. Taking the semantic segmentation method as an example, the processing circuit 140 can perform the graph-based segmentation operation upon the captured data to generate a processed image to identify the area of sky, ground, vertical object (building/traffic light), . . . and so on. For example, a machine learning technique can be applied to learn the difference among areas, if there is a blue/white continuous region on the top of the image which is smooth inside and wide enough, the processing circuit 140 can determine that the region is the sky. In addition, taking the deep learning based scene classification as an example, the processing circuit 140 may use semantic segmentation as an input, then utilize the convolutional neural network (CNN) algorithm to predict the surrounding environment and its confidence information based on the environmental data provided by the visual sensor 130, to identify if the surroundings comprises the tall building, the tunnel or the urban canyon that may influence the satellite signals, to predict the scene category and determine the best positioning strategy. It is noted that because the present invention does not focus on the implementations of the image recognition method, and there are many the image recognition methods and the image identification methods that are well known by a person skilled in the art, the detailed descriptions about the image recognitions are therefore omitted here.

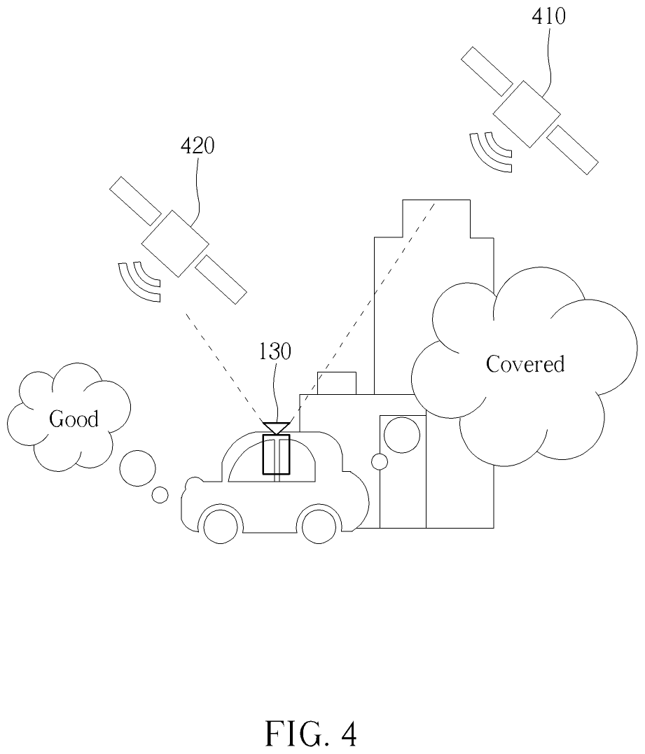

In the embodiment shown in FIG. 2 and FIG. 3, the visual sensor 130 is a side-view visual sensor that provides the front environmental data to the processing circuit 140 to perceive the bad satellite signals by using the vision-aided algorithm. In another embodiment, however, the visual sensor 130 may be a top-view visual sensor as shown in FIG. 4. In the embodiment shown in FIG. 4, the visual sensor 130 can capture the data above the vehicle to generate the surrounding environment information to the processing circuit 140, and the processing circuit 140 may refer to the surrounding environment information to determine which one of the satellite signals may be unreliable. For example, if the sensing data captured by the visual sensor 130 shows that there is no barrier between the satellite 420 and the vehicle, the processing circuit 140 can determine that the satellite signals generated by the satellite 420 are reliable; and if the sensing data captured by the visual sensor 130 show that there is a barrier between the satellite 410 and the vehicle, the processing circuit 140 can determine that the satellite signals generated by the satellite 410 are unreliable, and the satellite signals generated by the satellite 410 may not be used in the positioning operations. In light of above, by selecting the reliable satellite signals and ignoring the unreliable satellite signals, the processing circuit 140 can determine the location and navigation of the vehicle more accurately.

In addition, the inertial sensor 120 shown in FIG. 1 are for illustrative purposes only, in other embodiments, the inertial sensor 120 can be replaced by another source such as an electrical compass or an odometer. As long as the processing circuit 140 receive the first positioning information and the second positioning information from a first source and a second source, respectively, and refers to the surrounding environment information from the visual sensor to determine the positioning strategy to use at least one of the first positioning information and the second positioning information to obtain the location of the vehicle, these alternative designs shall fall within the scope of the present invention.

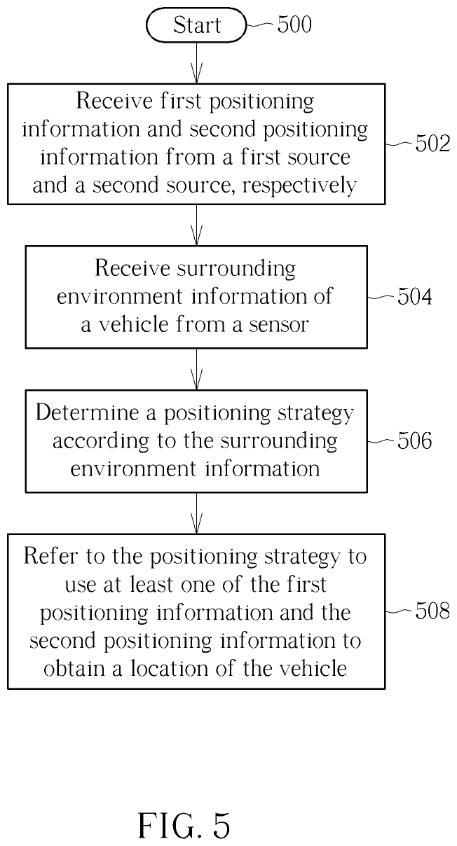

FIG. 5 is a flowchart of a method for performing positioning operations according to one embodiment of the present invention. Refer to the FIGS. 1-5 and above descriptions, the flow is described as follows.

Step 500: the flow starts.

Step 502: receive first positioning information and second positioning information from a first source and a second source, respectively.

Step 504: receive surrounding environment information of a vehicle from a sensor.

Step 506: determine a positioning strategy according to the surrounding environment information.

Step 508: refer to the positioning strategy to use at least one of the first positioning information and the second positioning information to obtain a location of the vehicle.

Briefly summarized, in the method for performing positioning operations and the hybrid positioning system of the present invention, by using the sensor to obtain the surrounding environment information to determine the appropriate positioning strategy for the hybrid positioning system, the positioning information provided by the GNSS receiver and the inertial sensor can be used in the most appropriate manner at the most appropriate time, and the calculated location and navigation information will be more accurate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing positioning operations, comprising:
receiving first positioning information from a first source;
receiving second positioning information from a second source;
obtaining surrounding environment information of a vehicle from a sensor; and
referring to the surrounding environment information to determine a positioning strategy to use at least one of the first positioning information and the second positioning information to obtain a location of the vehicle.

2. The method of claim 1, wherein the first source is a Global Navigation Satellite System (GNSS) receiver, and the second source is inertial sensors, an electrical compass or an odometer.

3. The method of claim 1, wherein the step of referring to the surrounding environment information to determine the positioning strategy to use the at least one of the first positioning information and the second positioning information to obtain the location of the vehicle comprises:
referring to the surrounding environment information to determine confidences of the first positioning information and the second positioning information; and
using the first positioning information and the second positioning information and the corresponding confidences to obtain the location of the vehicle.

4. The method of claim 3, wherein the step of referring to the surrounding environment information to determine the confidences of the first positioning information and the second positioning information comprises:
determining a scene category of the vehicle according to the surrounding environment information; and
determining the confidences of the first positioning information and the second positioning information according to the scene category of the vehicle.

5. The method of claim 4, wherein the first source is a GNSS receiver, and the step of referring to the surrounding environment information to determine the confidences of the first positioning information and the second positioning information comprises:
if the surrounding environment information indicates that the vehicle is at an urban canyon or a tunnel, lowering the confidence of the first positioning information; and
if the surrounding environment information indicates that the vehicle is at open sky, increasing the confidence of the first positioning information.

6. The method of claim 4, wherein the second source is inertial sensors, an electrical compass or an odometer, and the step of referring to the surrounding environment information to determine the confidences of the first positioning information and the second positioning information comprises:
if the surrounding environment information indicates that the vehicle is in an urban canyon or a tunnel, increasing the confidence of the second positioning information; and
if the surrounding environment information indicates that the vehicle is in open sky scenario, lowering the confidence of the second positioning information.

7. The method of claim 1, wherein the sensor is a visual sensor.

8. The method of claim 7, wherein the sensor is a visual sensor comprising a camera, a LiDar, a millimeter wave radar, an ultrasonic radar or an infrared radar.

9. The method of claim 1, wherein the first source is a GNSS receiver, the first positioning information comprises satellite signals of a plurality of satellites, and the method further comprises:
referring to the surrounding environment information to select reliable satellite signals from the satellite signals of the plurality of satellites; and
wherein only the reliable satellite signals are used to obtain the location of the vehicle.

10. The method of claim 9, wherein the step of referring to the surrounding environment information to select the reliable satellite signals from the satellite signals of the plurality of satellites comprises:
referring to the surrounding environment information to determine a plurality of specific satellites, wherein there is no barrier between the specific satellites and the vehicle, and the satellite signals generated by the specific satellites serve as the reliable satellite signals.

11. A processing circuit configured to receive first positioning information from a first source, receive second positioning information from a second source, obtain surrounding environment information of a vehicle from a sensor, and refer to the surrounding environment information to determine a positioning strategy to use at least one of the first positioning information and the second positioning information to obtain a location of the vehicle.

12. The processing circuit of claim 11, wherein the first source is a Global Navigation Satellite System (GNSS) receiver, and the second source is inertial sensors, an electrical compass or an odometer.

13. The processing circuit of claim 11, wherein the processing circuit refers to the surrounding environment information to determine confidences of the first positioning information and the second positioning information, and uses the first positioning information and the second positioning information and the corresponding confidences to obtain the location of the vehicle.

14. The processing circuit of claim 13, wherein the processing circuit determines a scene category of the vehicle according to the surrounding environment information, and determines the confidences of the first positioning information and the second positioning information according to the scene category of the vehicle.

15. The processing circuit of claim 14, wherein the first source is a GNSS receiver, and if the surrounding environment information indicates that the vehicle is at an urban canyon or a tunnel, the processing circuit lowers the confidence of the first positioning information; and if the surrounding environment information indicates that the vehicle is at open sky, the processing circuit increases the confidence of the first positioning information.

16. The processing circuit of claim 14, wherein the second source is inertial sensors, an electrical compass or an odometer, and if the surrounding environment information indicates that the vehicle is at an urban canyon or a tunnel, the processing circuit increases the confidence of the second positioning information; and if the surrounding environment information indicates that the vehicle is at open sky, the processing circuit lowers the confidence of the second positioning information.

17. The processing circuit of claim 11, wherein the sensor is a visual sensor.

18. The processing circuit of claim 17, wherein the sensor is a visual sensor comprising a, a LiDar, a millimeter wave radar, an ultrasonic radar or an infrared radar.

19. The processing circuit of claim 11, wherein the first source is a GNSS receiver, the first positioning information comprises satellite signals of a plurality of satellites, and the processing circuit refers to the surrounding environment information to select reliable satellite signals from the satellite signals of the plurality of satellites, wherein only the reliable satellite signals are used to obtain the location of the vehicle.

20. The processing circuit of claim 19, wherein the processing circuit refers to the surrounding environment information to determine a plurality of specific satellites, wherein there is no barrier between the specific satellites and the vehicle, and the satellite signals generated by the specific satellites serve as the reliable satellite signals.
